(19) United States
(12) Patent Application Publication
(10) Pub. No.: US 2026/0309673 A1
(43) Pub. Date: Oct. 8, 2026

(54) ARRAY PROBE JIG

(71) Applicant: MITSUBISHI HEAVY INDUSTRIES, LTD., Tokyo (JP)

(72) Inventors: Takehiko YAMAGUCHI, Tokyo (JP); Kentaro JINNO, Tokyo (JP); Mikiyasu URATA, Tokyo (JP); Daisuke NAKAO, Tokyo (JP); Tadayoshi KIMURA, Kobe-shi (JP)

(73) Assignee: MITSUBISHI HEAVY INDUSTRIES, LTD., Tokyo (JP)

(21) Appl. No.: 19/161,979

(22) PCT Filed: Sep. 25, 2023
(86) PCT No.: PCT/JP2023/034683

§ 371 Date: Sep. 3, 2025

(30) Foreign Application Priority Data
Mar. 7, 2023 (JP) 2023-034364

(51) Int. Cl. G01N 27/9093; G01L 5/00; G01N 27/90; G01N 27/9013; G01N 27/904

(52) U.S. Cl. CPC G01N 27/9093; G01L 5/0038; G01N 27/9006; G01N 27/902; G01N 27/904

(57) ABSTRACT

An array probe jig according to the present disclosure can be attached to an array probe that includes a plurality of coil modules including an excitation coil and a detection coil, and a coil holder for holding the plurality of coil modules so as to be disposed on the same plane, the coil holder being formed from an elastically deformable material. The array probe jig comprises: a bag body which includes a pressing surface that presses the array probe against a part to be inspected and which is formed from a resilient material that can be expanded by means of a fluid filling the interior of the bag body; and a support member for supporting the bag body.

### TECHNICAL FIELD

The present disclosure relates to an array probe jig.

Priority is claimed based on Japanese Patent Application No. 2023-34364 filed on Mar. 7, 2023, the content of which is incorporated herein by reference.

### BACKGROUND ART

As a method for non-destructively inspecting defects such as scratches or a reduction in thickness at an inspection target location such as a welded portion, an eddy current flaw detection method is known. In this method, a coil module including an excitation coil that forms an eddy current on a surface of the inspection target location and a detection coil that detects the disturbance of the eddy current caused by defects at the inspection target location, based on an impedance change, is used. There is a case where one coil is used as the excitation coil and the detection coil. For example, a device described in PTL 1 below is known as a specific example of such a technique.

The device according to PTL 1 below includes a probe, fixing means for fixing an angle of the probe with respect to a subject, and a movable mechanism that allows the probe to be moved in a predetermined direction while holding the angle. When the probe is moved by the movable mechanism, the angle of the probe is continuously maintained, so that the probe can be normally brought into a face-to-face relationship with the subject.

### CITATION LIST

### Patent Literature

[PTL 1] Japanese U.S. Pat. No. 4,084,755

### SUMMARY OF INVENTION

### Technical Problem

However, in a welded portion or the like, it is generally the case that the welded portion or the like is irregular in shape and has a large number of small irregularities. Therefore, in the device according to PTL 1, although the angle can be maintained constant, it is difficult to continue to bring the probe into close contact with the surface of the welded portion. As a result, there is a problem in that the defect detection accuracy is limited.

The present disclosure has been made to solve the above-described problems, and an object of the present disclosure is to provide an array probe jig in which it is possible to detect a defect with higher accuracy by improving the close contact of an array probe with an inspection target location.

### Solution to Problem

In order to solve the above problems, according to the present disclosure, there is provided an array probe jig capable of being mounted on an array probe that includes a plurality of coil modules each including an excitation coil and a detection coil, and a coil holder that holds the plurality of coil modules so as to be arranged on the same plane and that is formed of an elastically deformable material, the array probe jig including: a bag body which has a pressing surface that presses the array probe against an inspection target location, and which is formed of an elastic material capable of being expanded by a fluid filling an interior of the bag body; and a supporting member that supports the bag body.

According to the present disclosure, there is provided an array probe jig capable of being mounted on an array probe that includes a plurality of coil modules each including an excitation coil and a detection coil, and a coil holder that holds the plurality of coil modules so as to be arranged on the same plane and that is formed of an elastically deformable material, the array probe jig including: an elastic member that biases the array probe in a direction toward an inspection target location; and a pressing member that is detachably provided at a tip of the elastic member and that has a pressing surface for pressing the array probe against the inspection target location.

### Advantageous Effects of Invention

According to the present disclosure, it is possible to provide an array probe jig in which it is possible to detect a defect with higher accuracy by improving the close contact of the array probe with the inspection target location.

### BRIEF DESCRIPTION OF DRAWINGS

FIG. 1 is a sectional view showing configurations of an array probe and an array probe jig according to a first embodiment of the present disclosure.

FIG. 2 is a plan view showing a configuration of the array probe jig according to the first embodiment of the present disclosure.

FIG. 3 is a view of a bag body according to the first embodiment of the present disclosure as viewed from a horizontal direction orthogonal to a scanning direction.

FIG. 4 is a schematic diagram showing the configurations of the bag body and a supporting member according to the first embodiment of the present disclosure.

FIG. 5 is a sectional view showing a first modification example of the array probe jig according to the first embodiment of the present disclosure.

FIG. 6 is a sectional view showing a second modification example of the array probe jig according to the first embodiment of the present disclosure.

FIG. 7 is a schematic diagram showing a third modification example of the array probe jig according to the first embodiment of the present disclosure.

FIG. 8 is a schematic diagram showing a fourth modification example of the array probe jig according to the first embodiment of the present disclosure.

FIG. 9 is a sectional view showing configurations of an array probe and an array probe jig according to a second embodiment of the present disclosure.

FIG. 10 is a sectional view showing configurations of an array probe and an array probe jig according to a third embodiment of the present disclosure.

FIG. 11 is a schematic diagram showing a modification example of the array probe jig common to the respective embodiments of the present disclosure.

### DESCRIPTION OF EMBODIMENTS

### First Embodiment

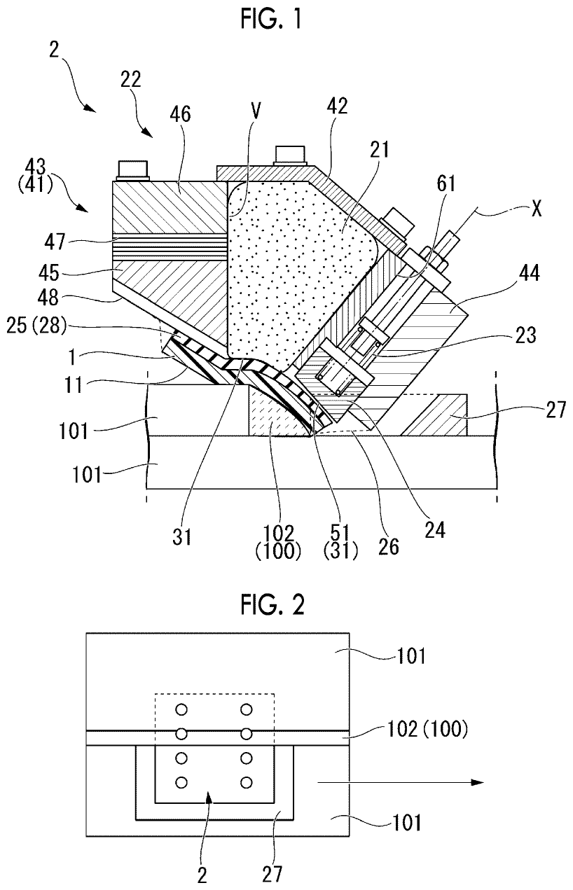

Hereinafter, an array probe 1 and an array probe jig 2 according to a first embodiment of the present disclosure will be described with reference to FIGS. 1 to 4. The array probe 1 is a device for performing flaw detection inspection by an eddy current with respect to, for example, an inspection target location 100 shown in FIG. 1. In the example of FIG. 1, as the inspection target location 100, a fillet weld portion 102 formed between an end surface of one of two plate members 101 overlapped with each other and a surface of the other of the two plate members 101 is shown. The fillet weld portion 102 has an arc-shaped surface in a sectional view and extends along the end surface of the plate member 101. The array probe jig 2 is used to bring the array probe 1 into close contact with the fillet weld portion 102 as described above.

### Configuration Of Array Probe 1

The array probe 1 has a plurality of coil modules (not shown) and a coil holder that holds the coil modules in a state of being arranged on the same plane. Each of the coil modules includes an excitation coil and a detection coil. The excitation coil generates an eddy current in the vicinity of the surface of the inspection target location 100. The detection coil detects a disturbance component in a case where the eddy current is disturbed due to a defect such as a crack or a reduction in thickness. As an example, each of the excitation coil and the detection coil has an annular shape, and a cross coil is formed in which one of the excitation coil and the detection coil is inserted into an inner periphery side of the other of the excitation coil and the detection coil such that axes of the excitation coil and the detection coil intersect with each other.

The coil holder has a plate shape integrally formed of an elastically deformable resin material. That is, the coil holder can be freely deformed to follow the curved shape of the fillet weld portion 102 or the like. The coil holder may be formed in a state of being curved with curvature from the beginning. The coil holder is formed with a plurality of recessed portions for accommodating the coil modules. The surface of the array probe 1 configured as described above, which faces the inspection target location 100 side, may be referred to as an inspection surface 11 in the following description.

### Configuration of Array Probe Jig 2

The array probe jig 2 includes a bag body 21, a supporting member 22, an elastic member 23, a pressing member 24, an elastic sheet member 25, a protective sheet member 26, and a guide member 27.

The bag body 21 is, for example, a bag-shaped balloon formed of rubber, silicone, or the like, and can be expanded by a fluid (for example, air) supplied from the outside. That is, by filling the interior of the bag body 21 with the fluid, the internal pressure of the bag body 21 rises, and it is possible to generate a surface pressure on a member adjacent to the outer side. In addition, the bag body 21 can be freely deformed to match the shape of a space that is formed by other members adjacent to each other on the outside. The surface of the bag body 21 facing the inspection target location 100 side forms a pressing surface 31 that presses the array probe 1 via the elastic sheet member 25 (described later) and the like.

The supporting member 22 supports the bag body 21 so as to surround the bag body 21 from the outer side. The supporting member 22 has a pair of split bodies 41 disposed to sandwich the bag body 21 therebetween, and a connection member 42 that connects the split bodies 41 to each other. One (first split body 43) of the split bodies 41 is located above the fillet weld portion 102 serving as the inspection target location 100, and the other (second split body 44) is located below the fillet weld portion 102. Among these, the first split body 43 is further configured with three members. That is, the first split body 43 includes a first member 45, a second member 46, and a shim member 47.

The first member 45 is supported by the second member 46 in a state of being able to be displaced in a direction of approaching or being separated from the inspection target location 100. The surface of the first member 45 facing the inspection target location 100 side is an inclined end surface 48. The inclined end surface 48 extends in a direction in which the inclined end surface 48 is gradually separated from the inspection target location 100 as the inclined end surface 48 is separated from the bag body 21. The second member 46 is located above the first member 45 (that is, on a side away from the inspection target location 100). A plurality of shim members 47 are inserted between the first member 45 and the second member 46. The shim member 47 is a plate member having a thickness determined in advance, and the height position of the first member 45 with respect to the second member 46 can be changed by appropriately changing the number of the shim members 47 to be inserted. That is, by increasing or decreasing the number of the shim members 47 in accordance with the size of the plate thickness of the plate member 101 at the inspection target location 100, it is possible to correspond to a step formed by the plate memberial 101. The first member 45 and the second member 46 are connected to each other by, for example, a bolt and a nut, and the shim members 47 are interposed in a gap between these members.

The second split body 44 is located on a side opposite to the first split body 43 with the bag body 21 interposed therebetween. The upper surface of the second split body 44 is integrally connected to the upper surface of the first split body 43 via the connection member 42. The second split body 44 is formed with an accommodation hole 61 for accommodating the elastic member 23 and the pressing member 24. A plurality of accommodation holes 61 are provided at intervals in a direction in which an end edge of the plate member 101 extends (that is, in a direction in which the array probe 1 performs scanning). The elastic member 23 is, for example, a compression coil spring. The elastic member 23 is fixed to the second split body 44. The pressing member 24 is detachably attached to a tip (an end portion on a side facing the array probe 1) of the elastic member 23. That is, the elastic member 23 biases the pressing member 24 toward the array probe 1 side.

As an example, the surface (inclined surface 51) of the pressing member 24 facing the array probe 1 side is inclined to intersect a central axis X of the coil spring serving as the elastic member 23 in a state of not being orthogonal to the central axis X. The inclined surface 51 forms a part of the pressing surface 31 for pressing the array probe 1, together with the bag body 21 described above. That is, the array probe 1 is pressed against the inspection target location 100 by the bag body 21 and the pressing member 24. In addition, the central axis X of the elastic member 23 extends in a direction inclined with respect to a direction normal to the plate member 101. More specifically, the central axis X extends in a radial direction of the surface of the fillet weld portion 102 having an arc shape. The surface of the fillet weld portion 102 may not be a complete arc. However, the “radial direction” referred to herein refers to a substantial radial direction when the arc is viewed macroscopically. In other words, the central axis X extends toward a joint portion between the plate members 101 (a lowermost end of the fillet weld portions 102 and an end edges of the upper plate member 101). The connection member 42 connects the first split body 43 and the second split body 44 to each other such that the second split body 44, the elastic member 23, and the pressing member 24 are in the posture as described above. That is, the connection member 42 is bent in a sectional view. In addition, the connection member 42 also serves as a lid that presses the bag body 21 so as not to protrude to the outside. Therefore, the first split body 43 and the second split body 44 may be integrally formed.

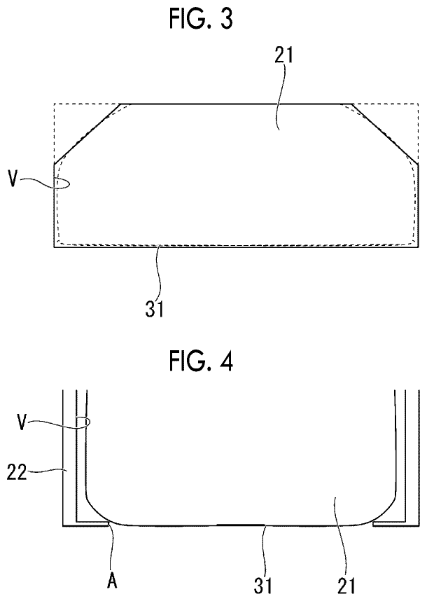

A space between the first split body 43 and the second split body 44 is an accommodation space V for accommodating the bag body 21. The accommodation space V is formed such that the cross-sectional area thereof gradually decreases toward the inspection target location 100 side when viewed from a direction in which the end edge of the plate member 101 extends. In addition, as shown in FIG. 3, when viewed from a horizontal direction orthogonal to the direction in which the end edge of the plate member 101 extends, a pair of corners above the accommodation space V are cut out. In this way, the accommodation space V has a smaller volume in a region located on a side opposite to the pressing surface 31 than in a region close to the pressing surface 31. Further, as shown in FIG. 4, an opening portion A is formed on a lower side of the accommodation space V (that is, a side facing the inspection target location 100). The volume of the pressing surface 31 of the bag body 21 is set to be sufficiently large with respect to the opening area of the opening portion A. In other words, the bag body 21 is configured such that only a part of the surface thereof is exposed from the opening portion A. Therefore, the pressing surface 31 exposed from the opening portion A is flat without being affected by the shape of the corner portion or the like of the bag body 21.

As shown in FIG. 1, the elastic sheet member 25 is interposed between the pressing surface 31 and the array probe 1. The elastic sheet member 25 is formed of a resin material that is elastically deformable, similarly to the coil holder. Specifically, as the material of the elastic sheet member 25, isoprene rubber, polyurethane rubber, rubber sheet (Nitrile-butadiene rubber, NBR), natural rubber, and the like can be considered. The elastic sheet member 25 can be elastically deformed in an integrated manner with the array probe 1 to follow the undulating shape of the inspection target location 100 by being pressed by the pressing surface 31. The material forming the coil holder of the array probe 1 may have a larger elastic modulus than the elastic sheet member 25 or may have a smaller elastic modulus than the elastic sheet member 25. In addition, a dilatant sheet member 28 having dilatant characteristics can be provided instead of the elastic sheet member 25 or together with the elastic sheet member 25. The dilatant characteristics refer to characteristics of showing high rigidity against a force that is applied in a short time and showing low rigidity against a force that is applied over a long time. In a case where the sheet of this type is used, it is possible to protect various wirings and the like laid on the surface of the array probe 1 on a side opposite to the inspection surface 11 from an external force.

The protective sheet member 26 covers the inspection surface 11 of the array probe 1 from the outer side. The protective sheet member 26 is provided to prevent the inspection surface 11 of the array probe 1 from being worn out due to friction with the inspection target location 100. As the protective sheet member 26, a cloth material such as a tent fabric, Teflon (registered trademark), Teflon (registered trademark) with a filler, or other resin materials can be used. In addition, the protective sheet member 26 is detachably attached to the first split body 43 and the second split body 44. Specifically, the protective sheet member 26 is fixed to the first split body 43 and the second split body 44 by an adhesive agent, a hook-and-loop fastener, or the like. Therefore, the protective sheet member 26 can be replaced in a case where the protective sheet member 26 is worn out.

The guide member 27 is provided to guide the array probe 1 and the array probe jig 2 along the fillet weld portion 102 of the inspection target location 100. As shown in FIG. 2, the guide member 27 has a C shape surrounding the first split body 43 and the second split body 44 from the outer side. Two end portions of the guide member 27 abut against the lower end of the fillet weld portion 102. That is, when the array probe 1 performs scanning along the fillet weld portion 102, the guide member 27 continues to abut against the fillet weld portion 102 on the front side and the rear side in a scanning direction, so that it is possible to continue the flaw detection inspection without deviating from the fillet weld portion 102.

### Operation and Effect

Next, an example of a method for handling the array probe 1 and the array probe jig 2 described above will be described. When performing the flaw detection inspection using the array probe 1, first, the tip of the guide member 27 described above is brought into contact with the fillet weld portion 102. Further, a fluid is injected into the bag body 21, and the array probe 1 is brought into close contact with the irregularities of the fillet weld portion 102 by an internal pressure of the bag body 21. At this time, the pressing member 24 is biased to the array probe 1 side by the elastic member 23, so that a state is created in which the array probe 1 is further deformed in accordance with the irregularities of the fillet weld portion 102. In this state, the flaw detection inspection by the array probe 1 is started, and the array probe 1 and the array probe jig 2 are moved (perform scanning) in a direction in which the fillet weld portion 102 extends. In a case where a defect such as a scratch or a reduction in thickness occurred in the fillet weld portion 102, the defect is appropriately visualized and analyzed by a monitor device (not shown). Here, in a welded portion or the like, it is generally the case that the welded portion or the like is irregular in shape and has a large number of small irregularities. Therefore, in the related art, there is a concern that the accuracy of the flaw detection inspection may be reduced due to the influence of the irregularities or the like. However, the array probe 1 and the array probe jig 2 according to the present embodiment solve this problem by adopting each configuration described above.

That is, according to the above-described configuration, the array probe 1 has the coil holder that can be elastically deformed, so that the array probe 1 itself easily follows a curved surface, a step, or the like. Further, the array probe 1 is pressed by the pressing surface 31 of the bag body 21, that is, the array probe 1 is pressed with a surface instead of a point, so that it is possible to perform the inspection while the array probe 1 is brought into closer contact with small irregularities such as a curved surface or a step. In this way, the accuracy of the inspection can be further improved. On the other hand, in a case where the array probe 1 cannot completely follow the irregularities, a gap is formed between the array probe 1 and the inspection target location 100, and the accuracy of the flaw detection inspection is lowered due to the influence of the gap. According to the above-described configuration, it is possible to reduce such a possibility and to perform the flaw detection inspection with high accuracy and stability. In addition, the internal pressure of the bag body 21 can be freely changed by appropriately adjusting the amount of the fluid that is injected into the bag body 21. In this way, the surface pressure that is generated on the pressing surface 31 can be appropriately adjusted. Therefore, the array probe 1 can be used for the inspection target location 100 having various shapes. That is, the versatility of the array probe jig 2 can be improved.

Further, according to the above-described configuration, the array probe 1 is pressed by the pressing member 24 in addition to the bag body 21, so that it is possible to perform the inspection while the array probe 1 is brought into closer contact with small irregularities such as a curved surface or a step. In this way, the accuracy of the inspection can be further improved. In particular, the pressing force can be freely changed by appropriately changing the spring constant of the coil spring as the elastic member 23. In this way, the array probe 1 can be used for the inspection target location 100 having various shapes. That is, the versatility of the array probe jig 2 can be improved.

According to the above-described configuration, the elastic sheet member 25 is interposed, so that the surface pressure between the array probe 1 and the pressing surface 31 can be uniformly distributed. In this way, the array probe 1 can be brought into closer contact with the inspection target location 100. In addition, according to the above-described configuration, the dilatant sheet member 28 having dilatant properties is provided, so that various wirings and the like provided on the pressing surface 31 side of the array probe 1 can be protected from an external force. In this way, troubles such as disconnection are avoided, and it is possible to stably and smoothly continue the inspection. On the other hand, in a case where the elastic sheet member 25 or the dilatant sheet member 28 is not provided, it is necessary to elastically deform the array probe 1, only based on the flexibility of the coil holder of the array probe 1. For this reason, the pressing force of the bag body 21 or the like may not be uniformly applied depending on the position, and there is a possibility that the followability of the array probe 1 is reduced. However, according to the above-described configuration, such a possibility is reduced, and the array probe 1 can be brought into surface contact with the inspection target location 100 more closely.

In addition, according to the above-described configuration, the surface (the inspection surface 11) of the array probe 1 on a side facing the inspection target location 100 is protected by the protective sheet member 26. In this way, wear of or damage to the array probe 1 due to friction with the inspection target location 100 can be avoided. Therefore, it is possible to further extend the life of the array probe 1. Further, since the protective sheet member 26 is detachably attached, the protective sheet member 26 can be immediately replaced with a new protective sheet member in a case where the protective sheet member 26 is worn out. In this way, it is possible to improve the availability of the array probe jig 2.

In addition, according to the above-described configuration, the shim member 47 is attached to and detached from between the first member 45 and the second member 46, so that the separation distance between the inspection target location 100 and the first member 45 can be changed. That is, the height position of the first member 45 can be freely adjusted. Therefore, even in a case where there is a step portion formed by overlapping two plate members 101 as described above, the pressing force against the array probe 1 can be secured by changing the position of the first member 45 in accordance with the size of the step (the thickness of the plate member 101). As a result, the array probe 1 can be made to more flexibly follow the inspection target location 100.

The first embodiment of the present disclosure has been described above. Various changes and modifications can be made to the above configuration within a scope which does not depart from the gist of the present disclosure.

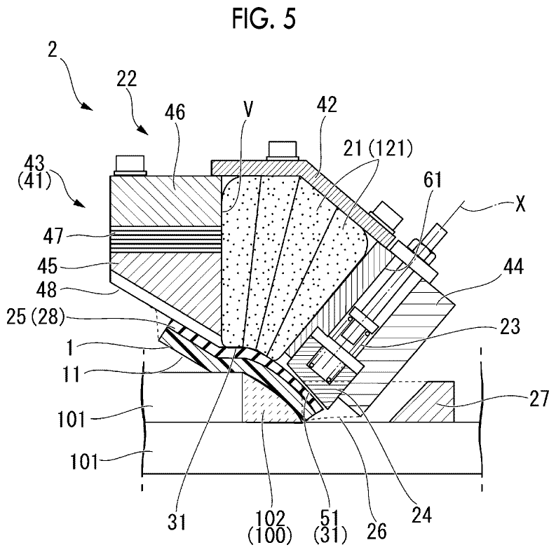

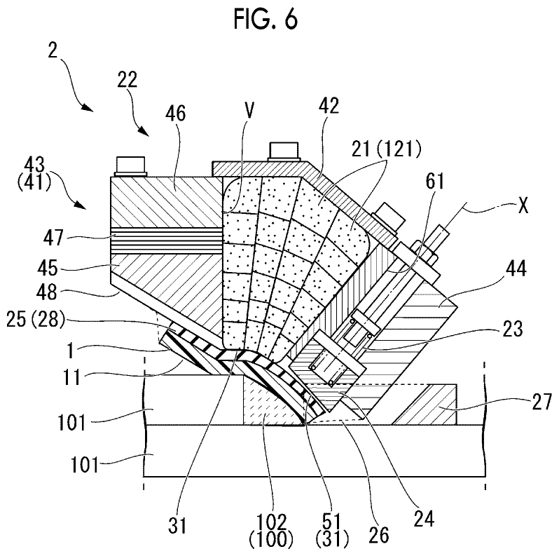

For example, as shown as a first modification example in FIG. 5, the bag body 21 can be divided and disposed into a plurality of small bag bodies 121. In the example of FIG. 5, the bag body 21 is divided into a plurality of parts in a direction along the pressing surface 31. According to this configuration, even in a case where some of the small bag bodies 121 are damaged, a space corresponding to the damaged small bag body 121 can be supplemented by further expanding the other small bag bodies 121. Therefore, it is possible to continue the inspection without causing a change in surface pressure on the pressing surface 31. That is, it is possible to improve the robustness and availability of the device itself. In addition, as shown as a second modification example in FIG. 6, it is also possible to configure the bag body 21 with a larger number of small bag bodies 121 than those in the example of FIG. 5. According to this configuration, since a large number of the small bag bodies 121 are provided, the internal pressure can be evenly exerted even in a corner portion or the like of the accommodation space V. In this way, the surface pressure on the pressing surface 31 can be further uniformly and stably maintained regardless of the location.

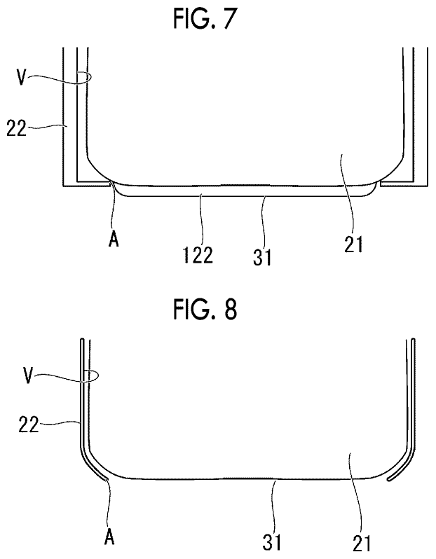

Further, as shown as a third modification example in FIG. 7, a protrusion portion 122 that protrudes from the opening portion A may be formed in advance on a surface of the bag body 21 facing the opening portion A of the accommodation space V. That is, the shape of the bag body 21 is determined in advance such that the protrusion portion 122 is naturally formed by injecting a fluid into the bag body 21. According to this configuration, the protrusion portion 122 protruding from the opening portion A in an expanded state is formed in the bag body 21 in advance, so that it is possible to sufficiently secure the surface pressure on the pressing surface 31 by the shape of the protrusion portion 122 without excessively increasing the internal pressure of the bag body 21. In addition, it is possible to avoid deterioration or the like of the bag body 21 due to a high internal pressure. In addition, as shown in FIG. 8, it is also possible to form a wall portion of the accommodation space V in a curved surface shape in accordance with the curved outer shape of the bag body 21. According to this configuration, the pressing force by the bag body 21 can be concentrated on the pressing surface 31 without any waste. As a result, the pressing force against the array probe 1 increases, and the array probe 1 can be further elastically deformed with good followability.

### Second Embodiment

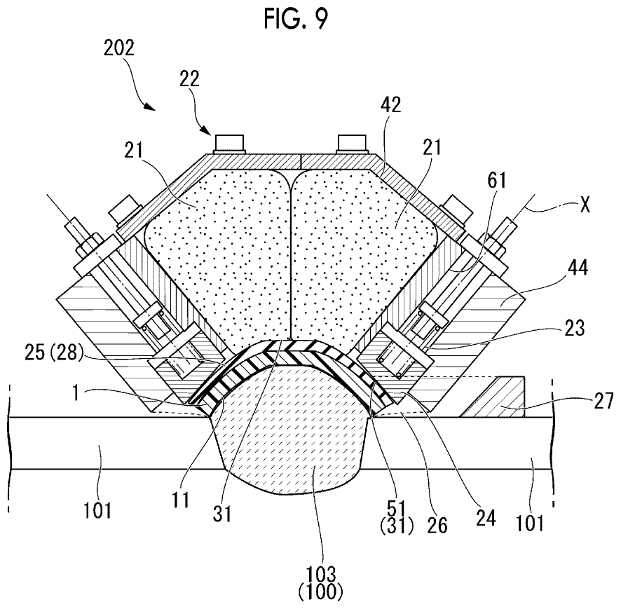

Subsequently, an array probe jig 202 according to a second embodiment of the present disclosure will be described with reference to FIG. 9. The same configurations as in the first embodiment described above are denoted by the same reference numerals, and detailed description thereof is omitted.

In the present embodiment, the shape of the inspection target location 100 is different from that in the first embodiment. Accordingly, the configuration of the array probe jig 2 is also different from that in the first embodiment. Specifically, as shown in FIG. 9, the inspection target location 100 is a butt weld portion 103 formed between a pair of plate members 101 butt-welded to each other. The surface of the butt weld portion 103 protrudes in a curved surface shape in the plate thickness direction of the plate member 101. The array probe jig 202 can be elastically deformed such that the array probe 1 follows the curved surface shape.

More specifically, the array probe jig 202 has a configuration in which two array probe jigs 2 described in the first embodiment are connected to each other to be symmetrical with respect to the butt weld portion 103. That is, each of the bag body 21, the elastic member 23, and the pressing member 24 described above are provided two by two. Each of the elastic members 23 extends toward the curved surface of the butt weld portion 103 so as to coincide with the radial direction of the arc formed by the curved surface. The surface of the butt weld portion 103 may not be a complete arc. However, the “radial direction” referred to herein refers to a substantial radial direction when the arc is viewed macroscopically.

According to the above-described configuration, it is possible to perform the flaw detection inspection with high accuracy and stability even on the butt weld portion 103 with the same operation and effect as those described in the first embodiment. In addition, as described above, the array probe jig 202 can be configured by connecting two array probe jigs 2 described in the first embodiment. In this way, the versatility of the array probe jig 2 can be further improved by changing the device so as to correspond to each of the fillet weld portion 102 and the butt weld portion 103. As a result, the manufacturing cost and the maintenance cost of the device can be reduced, and the number of components to be managed can be reduced. Therefore, the economy of the flaw detection inspection can be further improved.

The second embodiment of the present disclosure has been described above. Various changes and modifications can be made to the above configuration within a scope which does not depart from the gist of the present disclosure.

### Third Embodiment

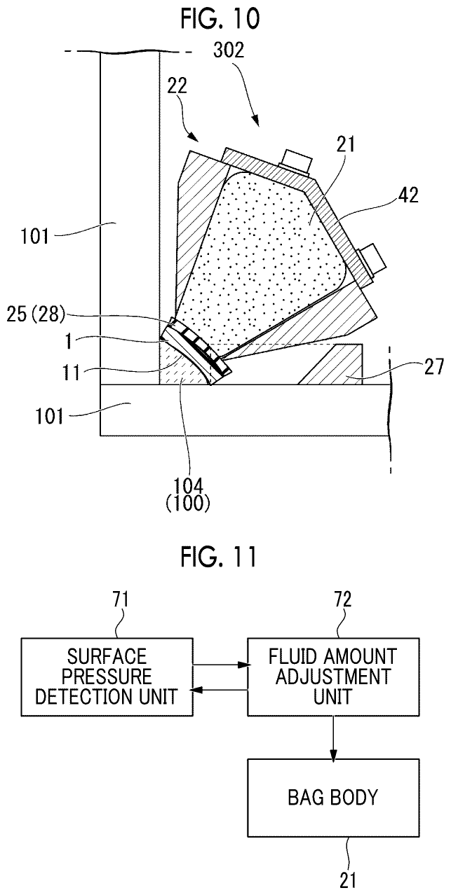

Next, an array probe jig 302 according to a third embodiment of the present disclosure will be described with reference to FIG. 10. The same configurations as in each of the embodiments described above are denoted by the same reference numerals, and detailed description thereof is omitted.

As shown in FIG. 10, in the present embodiment, as the inspection target location 100, a triangular fillet weld portion 104 formed when two plate members 101 are assembled in an L shape is given as an example. The fillet weld portion 104 is formed inside a corner formed by the two plate members 101. The array probe jig 302 has a configuration as shown in FIG. 10 in accordance with the fillet weld portion 104. That is, the array probe jig 302 includes the supporting member 22, one bag body 21, the connection member 42, the guide member 27, the elastic sheet member 25, and the protective sheet member 26. In the example of FIG. 10, the elastic member 23 and the pressing member 24 are not provided for space saving. In addition, the supporting member 22 is formed to be thinner than in the first embodiment in order to correspond to a narrow space.

According to the above-described configuration, it is possible to perform the flaw detection inspection with high accuracy and stability even on the fillet weld portion 104 formed in a narrow region, with the same operation and effect as those described in the first embodiment.

The third embodiment of the present disclosure has been described above. Various changes and modifications can be made to the above configuration within a scope which does not depart from the gist of the present disclosure.

### Other Embodiments

The following items are examples of modifications common to the above-described embodiments and other embodiments.

In each of the above-described embodiments, an example in which air is used as the fluid filling the bag body 21 has been described. However, the fluid is not limited to air, and may be a liquid such as oil or alcohol. However, from the viewpoint of minimizing the influence when the bag body 21 is damaged and the fluid is dissipated, it is most desirable that the fluid is air.

In addition, the pressing surface 31 of the pressing member 24 is not limited to the above-described embodiments, and may have, for example, a cross-sectional shape that is recessed in a direction away from the array probe 1. Even in this case, the same operation and effect as those described above can be obtained.

Further, in the first embodiment and the second embodiment, an example in which the array probe 1 is pressed by using the bag body 21, the elastic member 23, and the pressing member 24 has been described. However, a configuration in which the array probe 1 is pressed only by the bag body 21 as in the third embodiment may be adopted. On the contrary, it is also possible to adopt a configuration in which the array probe 1 is pressed only by the elastic member 23 and the pressing member 24. In any of the configurations, the same operation and effect as those described above can be obtained.

In addition, the number of the bag bodies 21, the number of the elastic members 23, and the number of the pressing members 24 are not limited to the above-described respective embodiments, and can be appropriately increased or decreased according to a design, specifications, the area of the inspection target location 100, or the like.

In addition, a configuration in which only the elastic sheet member 25 is provided between the array probe 1 and the pressing surface 31 may be adopted, or a configuration in which the dilatant sheet member 28 is used together with the elastic sheet member 25 may be adopted. In this case, it is desirable to dispose the dilatant sheet member 28 on the array probe 1 side.

Furthermore, it is also possible to use a surface pressure sensor as a surface pressure detection unit 71 on a side opposite to the inspection surface 11 so as to come into contact with the array probe 1. The surface pressure detection unit 71 is a sensor that can quantify the distribution of the pressure for pressing the array probe 1. It is conceivable to provide a fluid amount adjustment unit 72 that adjusts the amount of the fluid that is supplied to the bag body 21 such that the internal pressure of the bag body 21 falls within a range determined in advance, based on the detection result of the surface pressure detection unit 71 (FIG. 11). According to this configuration, the magnitude of the surface pressure on the pressing surface 31 is optimized, and the array probe 1 can be more reliably brought into close contact with the inspection target location 100.

In addition, when scanning the inspection target location 100 by using the array probe jig 2, the array probe jig 2 may be moved manually, or the array probe jig 2 may be mounted on a self-propelled carriage or the like to autonomously scan the inspection target location 100. In any of the configurations, the same operation and effect as those described above can be obtained.

### Additional Remark

The array probe jig 2 described in each embodiment is understood as follows, for example.

(1) An array probe jig 2 according to a first aspect is an array probe jig 2 capable of being mounted on an array probe 1 that includes a plurality of coil modules each including an excitation coil and a detection coil, and a coil holder that holds the plurality of coil modules so as to be arranged on the same plane and that is formed of an elastically deformable material, the array probe jig 2 including: a bag body 21 which has a pressing surface 31 that presses the array probe 1 against an inspection target location 100, and which is formed of an elastic material capable of being expanded by a fluid filling an interior of the bag body 21; and a supporting member 22 that supports the bag body 21.

According to the above-described configuration, the array probe 1 has the coil holder that can be elastically deformed, so that the array probe 1 itself easily follows a curved surface, a step, or the like. Further, the array probe 1 is pressed by the pressing surface 31 of the bag body 21, so that it is possible to perform inspection while the array probe 1 is in close contact with small irregularities such as a curved surface or a step. In this way, the accuracy of the inspection can be further improved.

(2) In an array probe jig 2 according to a second aspect, the array probe jig 2 according to the first aspect further includes: an elastic member 23 that is disposed adjacent to the bag body 21 and that biases the array probe 1 in a direction toward the inspection target location 100; and a pressing member 24 that is detachably provided at a tip of the elastic member 23 and that forms a part of the pressing surface 31 for pressing the array probe 1 against the inspection target location 100.

According to the above-described configuration, the inspection can be performed while the array probe 1 is in close contact with small irregularities such as a curved surface or a step by pressing the array probe 1 with the pressing member 24. In this way, the accuracy of the inspection can be further improved.

(3) In an array probe jig 2 according to a third aspect, the array probe jig 2 according to the first or second aspect further includes an elastic sheet member 25 that is formed of an elastic material and that is interposed between the array probe 1 and the pressing surface 31.

According to the above-described configuration, the elastic sheet member 25 is interposed, so that the surface pressure between the array probe 1 and the pressing surface 31 can be uniformly distributed. In this way, the array probe 1 can be brought into closer contact with the inspection target location 100.

(4) In an array probe jig 2 according to a fourth aspect, the array probe jig 2 according to any one of the first to third aspects further includes a dilatant sheet member 28 that is formed of a material having dilatant properties and that is interposed between the array probe 1 and the pressing surface 31.

According to the above-described configuration, the dilatant sheet member 28 having dilatant properties is provided, so that various wirings and the like provided on the pressing surface 31 side of the array probe 1 can be protected from an external force. In this way, troubles such as disconnection are avoided, and it is possible to stably and smoothly continue the inspection.

(5) In an array probe jig 2 according to a fifth aspect, the array probe jig 2 according to any one of the first to fourth aspects further includes a protective sheet member 26 that is interposed between the array probe 1 and the inspection target location 100.

According to the above-described configuration, the surface of the array probe 1 facing the inspection target location 100 is protected by the protective sheet member 26. In this way, wear of or damage to the array probe 1 due to friction with the inspection target location 100 can be avoided. Therefore, it is possible to further extend the life of the array probe 1.

(6) In an array probe jig 2 according to a sixth aspect, the array probe jig 2 according to the fifth aspect further includes a lubrication portion capable of applying a lubricant between the protective sheet member 26 and the inspection target location 100.

According to the above-described configuration, by supplying the lubricant between the protective sheet and the inspection target location 100, it is possible to reduce the possibility that wear of or damage to the protective sheet itself occurs.

(7) In an array probe jig 2 according to a seventh aspect, in the array probe jig 2 according to any one of the first to sixth aspects, the supporting member 22 has a pair of split bodies 41 disposed to sandwich the bag body 21 therebetween, and the split body 41 includes a first member 45 displaceable in a direction of approaching the inspection target location 100 and a direction of being separated from the inspection target location 100, a second member 46 disposed to be spaced apart from the first member 45, and a shim member 47 that is detachably inserted between the first member 45 and the second member 46.

According to the above-described configuration, the shim member 47 is attached to and detached from between the first member 45 and the second member 46, so that the separation distance between the inspection target location 100 and the first member 45 can be changed. Therefore, even in a case where a step is formed in the inspection target location 100, it is possible to cause the array probe 1 to flexibly follow the step in accordance with the size of the step.

(8) In an array probe jig 2 according to an eighth aspect, the array probe jig 2 according to any one of the first to seventh aspects further includes: a surface pressure detection unit 71 that is provided between the inspection target location 100 and the array probe 1 and that is capable of detecting a surface pressure that is applied to the array probe 1; and a fluid amount adjustment unit 72 capable of adjusting an amount of the fluid filling the bag body 21 such that the surface pressure detected by the surface pressure detection unit 71 falls within a range determined in advance.

According to the above-described configuration, the inflow amount of the fluid into the bag body 21 is adjusted based on the surface pressure detected by the surface pressure detection unit 71. In this way, the magnitude of the surface pressure on the pressing surface 31 is optimized, and the array probe 1 can be more reliably brought into close contact with the inspection target location 100.

(9) In an array probe jig 2 according to a ninth aspect, in the array probe jig 2 according to any one of the first to eighth aspects, the bag body 21 includes a plurality of small bag bodies 121 that are adjacent to each other.

According to the above-described configuration, the bag body 21 is configured to include the plurality of small bag bodies 121. In this way, even in a case where some of the small bag bodies 121 are damaged, a space corresponding to the damaged small bag body 121 can be supplemented by further expanding the other small bag bodies 121. Therefore, it is possible to continue the inspection without causing a change in surface pressure on the pressing surface 31.

(10) In an array probe jig 2 according to a tenth aspect, in the array probe jig 2 according to any one of the first to ninth aspects, the supporting member 22 forms an accommodation space V in which the bag body 21 is disposed, and has an opening portion A that is open toward the array probe 1, and a protrusion portion 122 capable of protruding from the opening portion A in an expanded state is formed in the bag body 21 in advance.

According to the above-described configuration, since the protrusion portion 122 protruding from the opening portion A in an expanded state is formed in the bag body 21 in advance, it is possible to sufficiently secure the surface pressure on the pressing surface 31 by the shape of the protrusion portion 122 itself without excessively increasing the internal pressure of the bag body 21. In addition, it is possible to avoid deterioration or the like of the bag body 21 due to a high internal pressure.

(11) In an array probe jig 2 according to an eleventh aspect, in the array probe jig 2 according to the tenth aspect, the accommodation space V is formed to have a smaller volume in a region located on a side opposite to the pressing surface 31 than in a region close to the pressing surface 31.

According to the above-described configuration, since the volume of the region close to the pressing surface 31 in the accommodation space V is larger, most of the internal pressure of the bag body 21 can be effectively utilized as the surface pressure with respect to the pressing surface 31. In this way, the array probe 1 can be brought into closer contact with the inspection target location 100.

(12) An array probe jig 2 according to a twelfth aspect is an array probe jig 2 capable of being mounted on an array probe 1 that includes a plurality of coil modules each including an excitation coil and a detection coil, and a coil holder that holds the plurality of coil modules so as to be arranged on the same plane and that is formed of an elastically deformable material, the array probe jig 2 including: an elastic member 23 that biases the array probe 1 in a direction toward an inspection target location 100; and a pressing member 24 that is detachably provided at a tip of the elastic member 23 and that has a pressing surface 31 for pressing the array probe 1 against the inspection target location 100.

According to the above-described configuration, the inspection can be performed while the array probe 1 is in close contact with small irregularities such as a curved surface or a step by pressing the array probe 1 with the pressing member 24. In this way, the accuracy of the inspection can be further improved.

### REFERENCE SIGNS LIST

1: array probe
2: array probe jig
11: inspection surface
21: bag body
22: supporting member
23: elastic member
24: pressing member
25: elastic sheet member
26: protective sheet member
27: guide member
28: dilatant sheet member
31: pressing surface
41: split body
42: connection member
43: first split body
44: second split body
5: first member
46: second member
47: shim member
48: inclined end surface
51: inclined surface
61: accommodation hole
71: surface pressure detection unit
72: fluid amount adjustment unit
100: inspection target location
101: plate member
102: fillet weld portion
103: butt weld portion
104: fillet weld portion
121: small bag body
122: protrusion portion
202: array probe jig
302: array probe jig
A: opening portion
V: accommodation space
X: central axis

1. An array probe jig capable of being mounted on an array probe that includes a plurality of coil modules each including an excitation coil and a detection coil, and a coil holder that holds the plurality of coil modules so as to be arranged on the same plane and that is formed of an elastically deformable material, the array probe jig comprising:
a bag body which has a pressing surface that presses the array probe against an inspection target location, and which is formed of an elastic material capable of being expanded by a fluid filling an interior of the bag body;
a supporting member that supports the bag body;
an elastic member that is disposed adjacent to the bag body and that biases the array probe in a direction toward the inspection target location; and
a pressing member that is detachably provided at a tip of the elastic member and that forms a part of the pressing surface for pressing the array probe against the inspection target location, wherein
a surface of the pressing member facing the array probe side is inclined to intersect a central axis of a coil spring serving as the elastic member in a state of not being orthogonal to the central axis.

2. (canceled)

3. The array probe jig according to claim 1, further comprising:
an elastic sheet member that is formed of an elastic material and that is interposed between the array probe and the pressing surface.

4. The array probe jig according to claim 1, further comprising:
a dilatant sheet member that is formed of a material having dilatant properties and that is interposed between the array probe and the pressing surface.

5. The array probe jig according to claim 1, further comprising:
a protective sheet member that is interposed between the array probe and the inspection target location.

6. The array probe jig according to claim 5, further comprising:
a lubrication portion capable of applying a lubricant between the protective sheet member and the inspection target location.

7. The array probe jig according to claim 1, wherein the supporting member has a pair of split bodies disposed to sandwich the bag body therebetween, and
the split body includes
a first member displaceable in a direction of approaching the inspection target location and a direction of being separated from the inspection target location,
a second member disposed to be spaced apart from the first member, and
a shim member that is detachably inserted between the first member and the second member.

8. The array probe jig according to claim 1, further comprising:
a surface pressure detection unit that is provided between the inspection target location and the array probe and that is capable of detecting a surface pressure that is applied to the array probe; and
a fluid amount adjustment unit capable of adjusting an amount of the fluid filling the bag body such that the surface pressure detected by the surface pressure detection unit falls within a range determined in advance.

9. The array probe jig according to claim 1, wherein the bag body includes a plurality of small bag bodies adjacent to each other.

10. The array probe jig according to claim 1, wherein the supporting member forms an accommodation space in which the bag body is disposed, and has an opening portion that is open toward the array probe, and a protrusion portion capable of protruding from the opening portion in an expanded state is formed in the bag body in advance.

11. The array probe jig according to claim 10, wherein the accommodation space is formed to have a smaller volume in a region located on a side opposite to the pressing surface than in a region close to the pressing surface.

12. An array probe jig capable of being mounted on an array probe that includes a plurality of coil modules each including an excitation coil and a detection coil, and a coil holder that holds the plurality of coil modules so as to be arranged on the same plane and that is formed of an elastically deformable material, the array probe jig comprising:
an elastic member that biases the array probe in a direction toward an inspection target location; and
a pressing member that is detachably provided at a tip of the elastic member and that has a pressing surface for pressing the array probe against the inspection target location, wherein
a surface of the pressing member facing the array probe side is inclined to intersect a central axis of a coil spring serving as the elastic member in a state of not being orthogonal to the central axis.
